(19) United States
(12) Patent Application Publication
(10) Pub. No.: US 2025/0110770 A1
(43) Pub. Date: Apr. 3, 2025

(54) METHOD, DEVICE, AND COMPUTER PROGRAM PRODUCT FOR UPGRADING VIRTUAL STORAGE SYSTEM

(71) Applicant: DELL PRODUCTS L.P., ROUND ROCK, TX (US)

(72) Inventors: Bing Liu, Tianjin (CN); Cheng Wang, Beijing (CN); Xue Zhang, Beijing (CN); Simin Wang, Beijing (CN)

(21) Appl. No.: 18/538,315

(22) Filed: Dec. 13, 2023

(30) Foreign Application Priority Data
Sep. 28, 2023 (CN) 202311283467.7

(51) Int. Cl. G06F 9/455

(52) U.S. Cl. CPC G06F 9/45558; G06F 2009/45575; G06F 2009/45583

(57) ABSTRACT

The present disclosure relates to a method, a device, and a computer program product for upgrading a virtual storage system. The method for upgrading the virtual storage system is applied to a serverless platform, and includes receiving an upgrading instruction for the virtual storage system. The method further includes determining an upgrading type corresponding to the upgrading instruction and a preset execution file matched with the upgrading type, the preset execution file being pre-deployed in the serverless platform. The method further includes upgrading the virtual storage system by running the preset execution file in the serverless platform. In this way, a preset execution function is run in the serverless platform to upgrade the virtual storage system, which can save resource costs and operational costs for users. In addition, because the task processing efficiency of the serverless platform is high, the upgrading efficiency of the virtual storage system can further be improved.

### TECHNICAL FIELD

The present disclosure relates to the field of data storage, and more particularly, to a method, a device, and a computer program product for upgrading a virtual storage system.

### BACKGROUND

With the continuous increase of digital and networked business content, virtual storage systems have received more and more attention. A virtual storage system may centralize a plurality of storage medium modules (such as hard disks and disk arrays) to be subjected to unified management by a link (such as a server) in a network, so as to provide computing resources with large capacity and high data transmission performance for users.

The computing resources of the virtual storage system may be adjusted dynamically, and users follow a purchase principle of “pay what you use” to purchase computing resources corresponding to storage demands. With the increasing amount of business data that users need to process, it is necessary to upgrade the virtual storage system before continuing to utilize it to process the business data.

### SUMMARY OF THE INVENTION

Embodiments of the present disclosure provide a method, a device, and a computer program product for upgrading a virtual storage system. In an embodiment of the present disclosure, preset execution files corresponding to different upgrading types may be pre-deployed on a serverless platform. Then, a target preset execution file may be determined according to an upgrading type indicated in an upgrading instruction. Moreover, a virtual storage system is upgraded by running the target preset execution file on the serverless platform. In this way, the serverless platform may provide a more accurate and real-time billing mode. A user only needs to pay based on actually used computing resources, rather than paying for idle and unused resources, which can save resource costs and operational costs for the user. In addition, because the task processing efficiency of the serverless platform is high, the upgrading efficiency of the virtual storage system can further be improved.

In a first aspect of an embodiment of the present disclosure, a method for upgrading a virtual storage system is provided. The method is applied to a serverless platform, including receiving an upgrading instruction for the virtual storage system. The method further includes determining an upgrading type corresponding to the upgrading instruction and a preset execution file matched with the upgrading type, the preset execution file being pre-deployed in the serverless platform. The method further includes upgrading the virtual storage system by running the preset execution file in the serverless platform. In this way, a preset execution function is run in the serverless platform to upgrade the virtual storage system. Because the serverless platform may provide a more accurate and real-time billing mode, a user only needs to pay based on actually used computing resources, rather than paying for idle and unused resources, which can save resource costs and operational costs for the user. In addition, because the task processing efficiency of the serverless platform is high, the upgrading efficiency of the virtual storage system can further be improved.

In a second aspect of an embodiment of the present disclosure, an electronic device is provided. The electronic device includes one or more processors; and a storage apparatus for storing one or more programs, wherein the one or more programs, when executed by the one or more processors, cause the one or more processors to implement a method for upgrading a virtual storage system, and the method is applied to a serverless platform, including receiving an upgrading instruction for the virtual storage system. The method further includes determining an upgrading type corresponding to the upgrading instruction and a preset execution file matched with the upgrading type, the preset execution file being pre-deployed in the serverless platform. The method further includes upgrading the virtual storage system by running the preset execution file in the serverless platform.

In a third aspect of an embodiment of the present disclosure, a computer-readable storage medium is provided, and a computer program is stored thereon. The program, when executed by a processor, implements a method for upgrading a virtual storage system, and the method is applied to a serverless platform, including receiving an upgrading instruction for the virtual storage system. The method further includes determining an upgrading type corresponding to the upgrading instruction and a preset execution file matched with the upgrading type, the preset execution file being pre-deployed in the serverless platform. The method further includes upgrading the virtual storage system by running the preset execution file in the serverless platform.

It should be understood that the content described in the Summary of the Invention part is neither intended to limit key or essential features of the embodiments of the present disclosure, nor intended to limit the scope of the present disclosure. Other features of the present disclosure will become readily understood from the following description.

### BRIEF DESCRIPTION OF THE DRAWINGS

The above and other features, advantages, and aspects of the embodiments of the present disclosure will become more apparent with reference to the accompanying drawings and the following detailed description. In the accompanying drawings, identical or similar reference numerals represent identical or similar elements, in which:

FIG. 1 shows a schematic diagram of an example environment 100 in which a plurality of embodiments of the present disclosure can be implemented;

FIG. 2 shows a flow chart of a method for upgrading a virtual storage system according to some embodiments of the present disclosure;

FIG. 3 shows a schematic diagram of a process 300 of upgrading a virtual storage system by using a first preset execution file according to some embodiments of the present disclosure;

FIG. 4 shows a schematic diagram of a process 400 of expanding a memory of a virtual storage system by using a second preset execution file according to some embodiments of the present disclosure;

FIG. 5 shows a schematic diagram of a process 500 of switching a type of a virtual storage system by using a second preset execution file according to some embodiments of the present disclosure;

FIG. 6 shows an example environment 600 for determining a target time instant according to a work load and a use state of a virtual storage system;

FIG. 7 shows an example environment 700 for upgrading a virtual storage system according to some embodiments of the present disclosure; and

FIG. 8 shows a block diagram of a device that can implement a plurality of embodiments of the present disclosure.

### DETAILED DESCRIPTION

The embodiments of the present disclosure will be described below in further detail with reference to the accompanying drawings. Although the accompanying drawings show some embodiments of the present disclosure, it should be understood that the present disclosure may be implemented in various forms, and should not be explained as being limited to the embodiments stated herein. Rather, these embodiments are provided for understanding the present disclosure more thoroughly and completely. It should be understood that the accompanying drawings and embodiments of the present disclosure are for exemplary purposes only, and are not intended to limit the scope of protection of the present disclosure.

In the description of the embodiments of the present disclosure, the term “include” and similar terms thereof should be understood as open-ended inclusion, that is, “including but not limited to.” The term “based on” should be understood as “based at least in part on.” The term “an embodiment” or “the embodiment” should be understood as “at least one embodiment”. The terms “first,” “second,” and the like may refer to different or identical objects. Other explicit and implicit definitions may also be included below.

With the continuous increase of digital and networked business content, virtual storage systems have received more and more attention. A virtual storage system may centralize a plurality of storage medium modules (such as hard disks and disk arrays) to be subjected to unified management by a link (such as a server) in a network, so as to provide computing resources with large capacity and high data transmission performance for users.

The computing resources of the virtual storage system may be adjusted dynamically, and the users follow a purchase principle of “pay as much as you use” to purchase the computing resources corresponding to storage demands. With the increasing amount of business data that users need to process, it is necessary to upgrade the virtual storage system before continuing to utilize it to process the business data. For the users, how to save costs of upgrading the virtual storage system is of great importance. In a traditional upgrading solution, applications deployed in a virtual machine (VM) automatically upgrades the virtual storage system and drives various control nodes in an upgrading process, such as shutting down the virtual storage system and stating up the virtual storage system.

However, for the users, this method requires the deployment of additional applications to assist with upgrading, thereby increasing capital costs. The users also need to pay for physical servers, virtual machines, and other resources required for running the applications. The upgrading of the virtual storage system is not a high-frequency event, while the virtual machine needs to run continuously, thereby greatly increasing operational costs and capital costs. In addition, there are various types of upgrading methods for the virtual storage system, and all of them need to be performed by using the applications in the virtual machine, resulting in a low task decoupling degree.

Therefore, the embodiment of the present disclosure provides an upgrading solution for the virtual storage system. In the embodiment of the present disclosure, the virtual storage system may be upgraded in a serverless platform. First, an upgrading instruction for the virtual storage system is received, and an upgrading type corresponding to the upgrading instruction is determined. Then, a preset execution file matched with the upgrading type may be determined. The preset execution file is pre-deployed in the serverless platform. Different preset execution files may perform different types of upgrading on the virtual storage system, all the preset execution files are mutually independent, and the decoupling degree is relatively high. Finally, the preset execution file may be run in the serverless platform to upgrade the virtual storage system. In this way, the virtual storage system may be upgraded without the need for a virtual machine or deploying applications in a virtual machine to assist in the upgrading, so that the capital costs are saved. In addition, the preset execution function may be run only when receiving the upgrading instruction, and when the preset execution function is not triggered, there is no resource running, so that processing resources may also be saved on the basis of saving the operational costs.

In this way, the preset execution function is run in the serverless platform to upgrade the virtual storage system. Because the serverless platform may provide a more accurate and real-time billing mode, a user only needs to pay based on actually used computing resources, rather than paying for idle and unused resources, which can save resource costs and operational costs for the user. In addition, because task processing efficiency of the serverless platform is high, upgrading efficiency of the virtual storage system can further be improved.

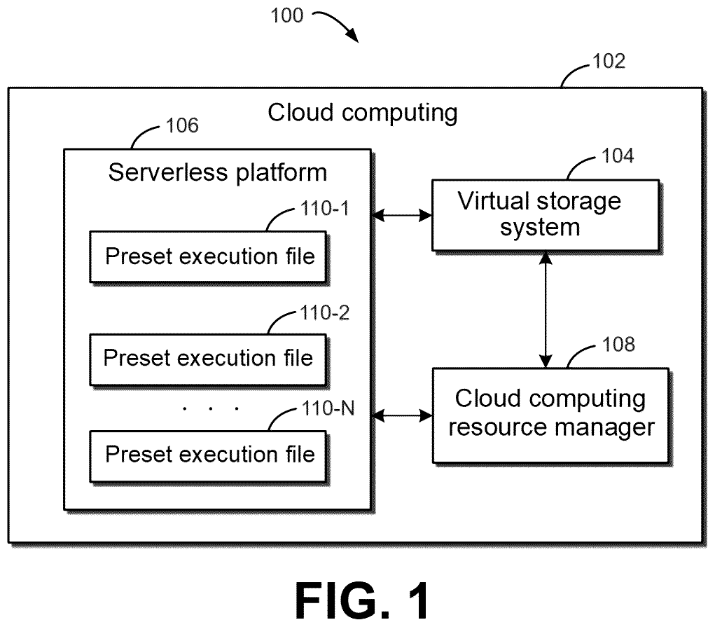

FIG. 1 shows a schematic diagram of an example environment 100 in which a plurality of embodiments of the present disclosure can be implemented. As shown in FIG. 1, the environment 100 includes cloud computing 102, a virtual storage system 104, and a serverless platform 106. The virtual storage system 104 and the serverless platform 106 may apply for computing resources, storage resources, and the like from the cloud computing 102. The cloud computing 102 is a computing model that separates resources from physical hardware and provides them to users as services. In the cloud computing 102, a central processing unit (CPU), a graphics processing unit (GPU), a memory, a hard disk, and other resources may be aggregated to form a virtual and infinitely expansible “computing power resource pool” through software. In a case that the users have demands for computing power, they can apply for resources from the cloud computing 102, and the “computing power resource pool” will dynamically allocate computing power resources. The cloud computing 102 may be a public cloud, which refers to a cloud provided by a third-party provider to the users that can be used, and the public cloud may be used through network services.

As shown in FIG. 1, the virtual storage system 104 may be in communication connection with the serverless platform 106, the virtual storage system 104 sends an upgrading instruction to the serverless platform 106, and the serverless platform 106 may respond to the upgrading instruction to upgrade the virtual storage system 104. Therefore, the operational costs and the capital costs can be saved, and the updating efficiency is improved. Alternatively, the serverless platform 106 may also receive an upgrading instruction for the virtual storage system 104 sent by the users (such as administrators and engineers), so as to upgrade the virtual storage system 104.

As shown in FIG. 1, the environment 100 may include a cloud computing resource manager 108. The virtual storage system 104 and the serverless platform 106 may send a resource request to the cloud computing resource manager 108. The cloud computing resource manager 108 may allocate computing resources for the virtual storage system 104 and the serverless platform 106 according to the resource request, so as to ensure normal using and normal upgrading of the virtual storage system.

As shown in FIG. 1, the serverless platform 106 includes a preset execution file 110-1, a preset execution file 110-2, . . . , and a preset execution file 110-N (collectively referred to as preset execution files 110). The preset execution file 110-1, the preset execution file 110-2, . . . , and the preset execution file 110-N are respectively deployed in various regions of the serverless platform 106. All the preset execution files 110 are mutually independent and used for executing different upgrading tasks. In the serverless platform 106, the virtual storage system 104 may be upgraded by running the preset execution files 110. A form of the preset execution files 110 is a function as a service (FaaS). The FaaS is a section of lightweight, unrelated, and reusable code that runs on a cloud. The users may write code by using languages (such as Java, Python, JavaScript, and node.js) supported by the cloud computing 102 according to upgrading demands and set conditions for code running to generate the FaaS.

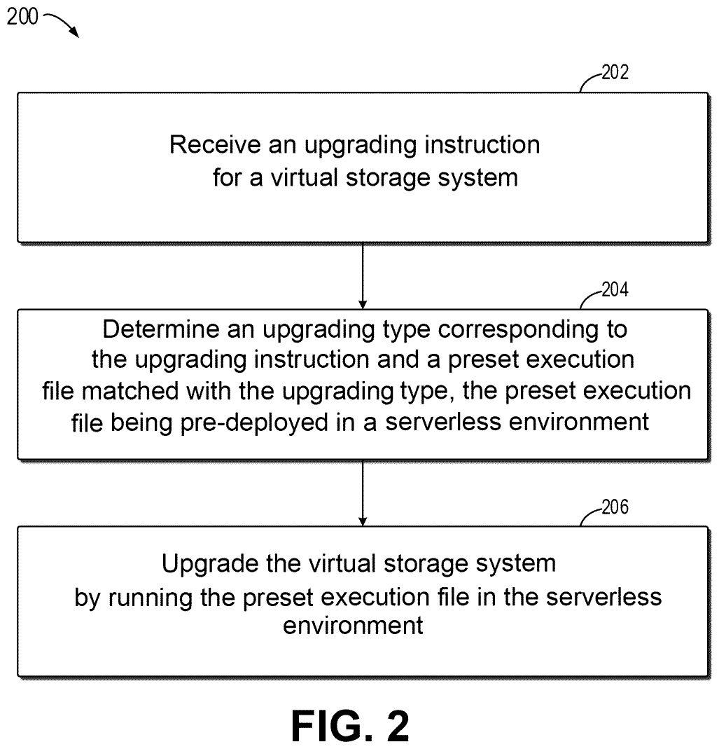

FIG. 2 shows a flow chart of a method 200 for upgrading a virtual storage system according to some embodiments of the present disclosure. As shown in FIG. 2, in a block 202, the method 200 receives an upgrading instruction for the virtual storage system. For example, an upgrading instruction sent by the virtual storage system is received, or an upgrading instruction sent by a user (such as an administrator) is received. The upgrading instruction may include an upgrading requirement, an upgrading type, and a target time instant of upgrading. The upgrading requirement refers to system resources required by the virtual storage system, such as CPU resources and storage resources. The upgrading type refers to an upgrading method of the virtual storage system, such as a first upgrading type and a second upgrading type. The target time instant of upgrading is used for indicating that the virtual storage system may be upgraded at the target time instant, or used for indicating a triggering time instant of the preset execution file.

In a block 204, the method 200 determines an upgrading type corresponding to the upgrading instruction and a preset execution file matched with the upgrading type. Different upgrading types correspond to different working processes, for example, the first upgrading type is to add a memory, and there is no need to shut down the virtual storage system; and the second upgrading type is to expand a capacity of the virtual storage system, and there is a need to shut down the virtual storage system. Therefore, in order to improve the upgrading efficiency and ensure the reliability of upgrading, there is a need to use different preset execution files to execute an upgrading task of the virtual storage system.

Further, different types of preset execution files, such as a first preset execution file (such as the preset execution file 110-1 shown in FIG. 1) and a second preset execution file (such as the preset execution file 110-2 shown in FIG. 1), may be pre-deployed in a serverless platform (such as the serverless platform 106 shown in FIG. 1). A user writes code according to the upgrading instruction to generate the preset execution files. For example, the user (such as an engineer) may write the code by using languages supported by the serverless platform and set conditions for code running to generate the preset execution files. Then, a mapping relationship between the upgrading types and the preset execution files may be established in the serverless platform. An expression form of the mapping relationship may be a mapping relationship table, a mapping relationship model, a mapping relationship function, and the like. In this way, the preset execution files matched with the upgrading types may be determined according to the mapping relationship. For example, the preset execution file matched with the first upgrading type is a first preset execution file.

Continuing to refer to FIG. 2, in a block 206, the method 200 upgrades the virtual storage system by running the preset execution file in the serverless platform. Since the preset execution file contains an executable command set, the executable command set may combine different commands and automatically execute them successively in a determined order. Therefore, by triggering and executing the preset execution file, the virtual storage system may be upgraded according to a set working process. When the preset execution file is invoked, the serverless platform may allocate the system resources for the preset execution file and start up a host environment to run the preset execution file.

In this way, the method 200 can run the preset execution file in the serverless platform to upgrade the virtual storage system. Because the serverless platform may provide an accurate and real-time billing mode, in a process of upgrading the virtual storage system by using the preset execution file, it is only needed to pay based on actually used computing resources, rather than paying for idle and unused resources, which can save resource costs and operational costs for the user. At the same time, different preset execution files may be used for performing different types of upgrading of the virtual storage system, the comprehensiveness and reliability of an upgrading system may be ensured, and upgrading efficiency may be further improved.

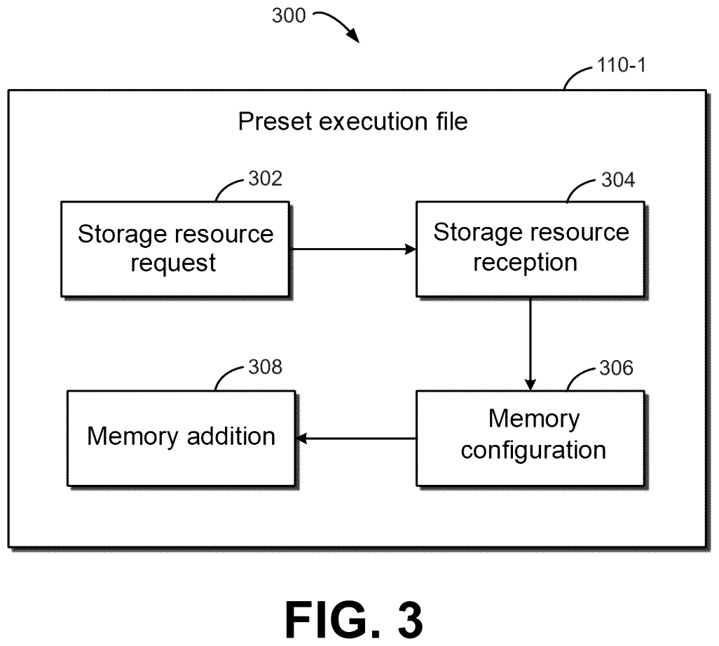

In some embodiments, a new virtual memory may be added to the virtual storage system (such as the first upgrading type) through the first preset execution file to upgrade the virtual storage system. An example implementation of upgrading the virtual storage system by using the first preset execution file is described in conjunction with FIG. 3 below. FIG. 3 shows a schematic diagram of a process 300 of upgrading a virtual storage system by using a first preset execution file according to some embodiments of the present disclosure. In some embodiments, as shown in FIG. 3, in a block 302, a storage resource request may be sent to a cloud computing platform (such as the cloud computing 102 shown in FIG. 1) provided by a cloud service provider by using a preset execution file 110-1. For example, the preset execution file may achieve data share and interaction with the cloud computing platform through a cloud application programming interface (API). A size of storage resources indicated by the storage resource request may be determined according to an upgrading requirement, for example, the upgrading requirement is to add a memory with a capacity of 1 TB to the virtual storage system, and the indicated storage resources are resources with a storage capacity of 1 TB.

In some embodiments, the size of the storage resources indicated by the storage resource request may be determined according to a use state and configuration information of the virtual storage system. The use state of the virtual storage system refers to a use capacity and a remaining capacity of a storage space of the virtual storage system. The configuration information refers to a maximum capacity of the storage space allowed by the virtual storage system, a size of a virtual memory, and a size of a virtual central processing unit. In some embodiments, a serverless platform (such as the serverless platform 106 shown in FIG. 1) may acquire the configuration information and the use state through network connection with a virtual storage system (such as the virtual storage system 104 shown in FIG. 1). The size of the storage resources is determined according to a difference value between the remaining capacity of the storage space and the maximum capacity of the storage space.

Further, in order to avoid frequently upgrading the virtual storage system in a short period of time, the size of the storage resources may be adjusted according to a size of remaining storage data and a data reading speed of the virtual storage system. For example, when the data reading speed is high and the data volume of the remaining storage data is large, a plurality of memories may be added, or the storage capacity of the added memory may be increased. In this way, the size of the storage resources may be appropriately increased.

Continuing to refer to FIG. 3, in a block 304, the first preset execution file may receive a request result and the required storage resources returned by the cloud computing platform through the cloud API. In a block 306, a new memory may be configured by using the first preset execution file according to the received storage resources, such as configuring a memory with a capacity of 1 TB. In a block 308, the first preset execution file may add the new memory to the virtual storage system through the cloud API. In this way, the virtual storage system may convert the new memory into a memory in the system through the API in the system to store business data.

In some embodiments, expanding the capacity of the existing memory of the virtual storage system or switching the type of the virtual storage system belongs to the second upgrading type. The different types of virtual storage systems have different configuration information and supported system resources. For example, a maximum capacity allowed by a virtual storage system type 1 is 16 TB, a size of the virtual central processing unit is 4 G, and a size of the virtual memory is 16 G. A maximum capacity allowed by a virtual storage system type 2 is 32 TB, a size of the virtual central processing unit is 8 G, and a size of the virtual memory is 32 G.

When the upgrading of the second upgrading type is performed on the virtual storage system, there is a need to shut down the virtual storage system in the process of upgrading the virtual storage system. This is different from an upgrading working process corresponding to the first upgrading type, and therefore, the virtual storage system may be upgraded by using the second preset execution file. After shutting down the virtual storage system, the second preset execution file may apply for system resources required for upgrading the virtual storage system from a cloud computing platform (such as the cloud computing platform 102 shown in FIG. 1) through a cloud computing resource manager (such as the cloud computing resource manager 110 shown in FIG. 1). Then, the second preset execution file may upgrade the virtual storage system based on the system resources, so as to expand the maximum capacity allowed by the virtual storage system. Finally, after completing the upgrading of the virtual storage system, the second preset execution file may start up the virtual storage system, so that the virtual storage system may be normally used again. It may be understood that after the virtual storage system is started up again, the resources required for processing the business data may be reconfigured.

In this way, the virtual storage system may be upgraded by running the second preset execution file on the serverless platform. Additional applications are not needed to control startup and shutdown of the virtual storage system, which saves the operational costs and capital costs. Moreover, this method may execute the upgrading working process smoothly and efficiently, so that the upgrading efficiency is improved.

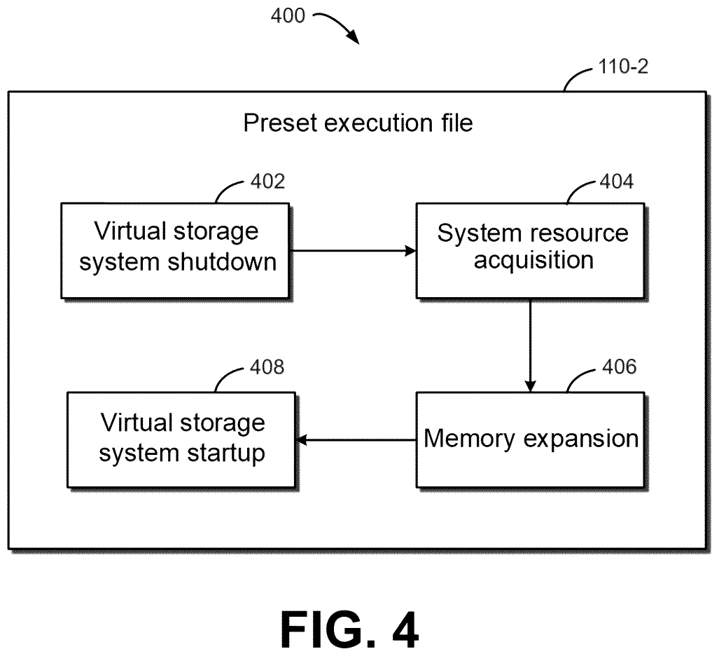

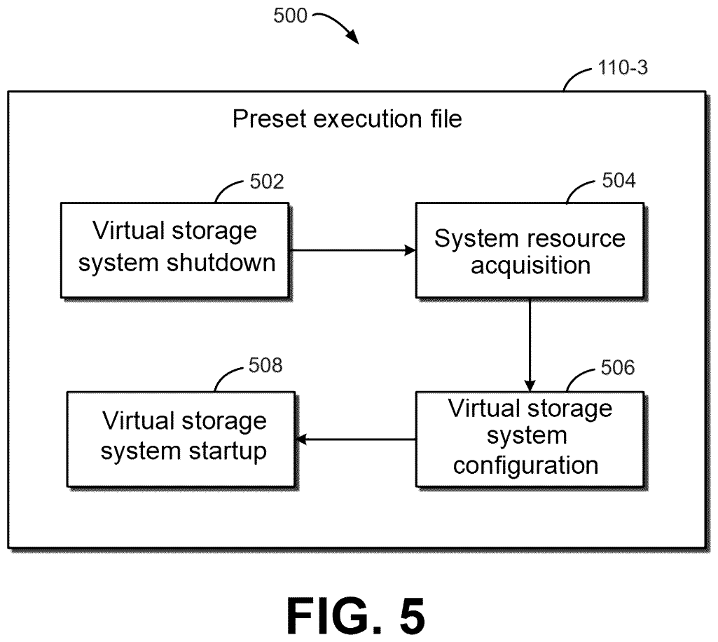

In some embodiments, there are two cases of the second upgrading type, and these two cases differ in the working process of upgrading the virtual storage system by using the second preset execution file. Therefore, the upgrading of two kinds of second upgrading type may be performed on the virtual storage system respectively by using the two types of second preset execution files. FIGS. 4 to 5 show a schematic diagram of a process 400 of expanding a memory of a virtual storage system by using a second preset execution file according to some embodiments of the present disclosure, and a schematic diagram of a process 500 of switching a type of a virtual storage system by using a second preset execution file according to some embodiments of the present disclosure.

As shown in FIG. 4, in a block 402, the virtual storage system may be shut down by using a preset execution file 110-2. For example, a state of the virtual storage system is set as “stopped.” In a block 404, the preset execution file 110-2 may apply for system resources required for expanding a capacity of an existing memory of the virtual storage system from a cloud computing platform (such as the cloud computing platform 102 shown in FIG. 1) through a cloud API. For example, when there is a need to expand the capacity of the existing memory of the virtual storage system from 1 TB to 2 TB, there is a need to apply for the system resources with a capacity of 1 TB from the cloud computing platform. In a block 406, the capacity of the memory of the virtual storage system may be expanded based on the system resources which are applied for by using the preset execution file 110-2, so as to upgrade the virtual storage system.

In some embodiments, due to the limited system resources supported by the virtual storage system, expanding the capacity of the memory of the virtual storage system needs to be performed in the supported system resources. Therefore, before upgrading the virtual storage system, there is a need to determine whether an expansion capacity of the memory indicated in an upgrading instruction meets a configuration of the virtual storage system. For example, it is acquired that the maximum capacity allowed by the virtual storage system is 96 TB. If the expansion capacity indicated in the upgrading instruction is 10 TB, and a use capacity of the virtual storage system is 20 TB, then the expansion capacity meets the maximum capacity allowed by the virtual storage system. In response to determining that the expansion capacity meets the system resources supported by the virtual storage system, the system resources required for upgrading the virtual storage system are acquired by using the second preset execution file. It may be understood that after the expansion capacity does not meet the system resources supported by the virtual storage system, exception warning information may be returned, prompting the user to purchase the required system resources as needed. In this way, an operation of upgrading the virtual storage system may be made in accordance with the normal upgrading flow.

As shown in FIG. 5, in a block 502, the virtual storage system may be shut down by using a preset execution file 110-3. In a block 504, the preset execution file 110-3 may apply for system resources required for switching the virtual storage system from a cloud computing platform (such as the cloud computing platform 102 shown in FIG. 1) through a cloud API. For example, when there is a need to switch a virtual storage system with a capacity of 16 TB to a virtual storage system with a capacity of 32 TB, there is a need to apply for the system resources with a capacity of 16 TB and other system resources from the cloud computing platform. In a block 506, the type of the virtual storage system may be switched based on the system resources which are applied for by using the preset execution file 110-3, so as to upgrade the virtual storage system. For example, the virtual storage system may be reconfigured, and a size of a virtual central processing unit and an allowable maximum capacity of the virtual storage system are changed to switch the type of the virtual storage system.

In some embodiments, the system resources used by the virtual storage system can only be used after the user pays for them. Switching the type of the virtual storage system may lead to an increase in the system resources used by the virtual storage system. Therefore, the user purchases the system resources as needed, and after obtaining a license, the system resources required for switching the virtual storage system may be acquired from the cloud computing platform. Further, after determining a target switching type of the virtual storage system by using the second preset execution file, system resources used by the target switching type of virtual storage system may be determined. Then, prompt information for adding a license may be returned. After the user purchases the system resources as needed, the cloud computing platform may generate the license. Then, after receiving the license corresponding to the target switching type by using the second preset execution file, the system resources required for switching the type of the virtual storage system may be acquired.

In some embodiments, during switching of the types of virtual storage systems, they can be sequentially switched in an arrangement order of the types. The arrangement order may be an order obtained by arranging the types of virtual storage systems in an ascending order of the maximum capacity allowed by the virtual storage system. For example, in a case that the arrangement order is type 1, type 2, and type 3, the virtual storage system is switched from type 1 to type 2. Alternatively, in order to avoid frequently upgrading the virtual storage system in a short period of time, the target switching type of the virtual storage system may further be selected according to actual storage demands and an application environment. Further, the target switching type of the virtual storage system may be determined according to a size of remaining storage data and a data reading speed of the virtual storage system. For example, in a case that the data volume of the remaining storage data is large and the data reading speed is high, the virtual storage system may be switched from type 1 to type 3, and the target switching type is type 3.

In this way, a proper target switching type may be selected for switching according to the application environment and application demands of the virtual storage system. Therefore, the problem of frequently switching the virtual storage system in a short period of time is avoided, and use experience of the user is further improved.

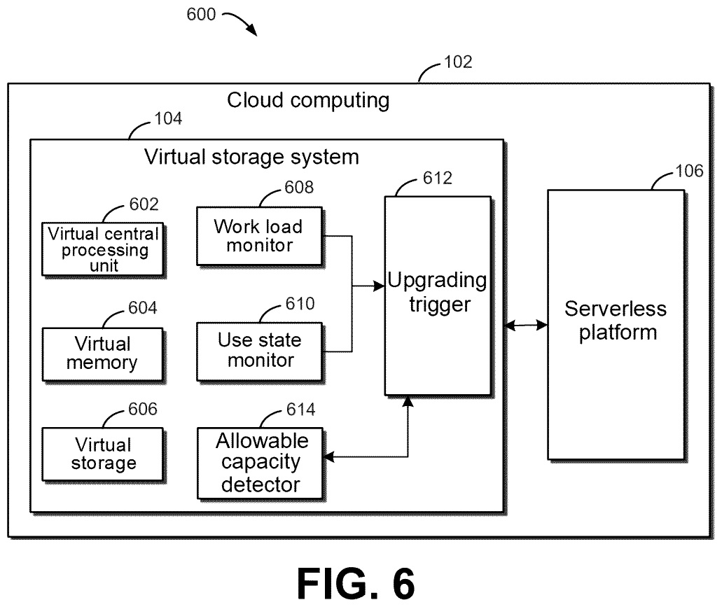

In some embodiments, the time point at which the virtual storage system is upgraded is crucial for the user. This is because upgrading the virtual storage system at an optimal upgrading time instant can maximize the legitimate interests of the user in a premise of ensuring the normal use of the virtual storage system. A target time instant of upgrading may be determined according to a work load and a use state of the virtual storage system. An example environment 600 for determining the target time instant according to the work load and the use state of the virtual storage system is described below in conjunction with FIG. 6.

As shown in FIG. 6, the environment 600 includes a virtual storage system 104 and a serverless platform 106. The virtual storage system 104 includes a central processing unit 602, a virtual memory 604, a virtual storage 606, a work load monitor 608, a use state monitor 610, and an upgrading trigger 612. The use state monitor 610 may monitor a use state of the virtual storage system 104. For example, a use state of the virtual storage 606 may be monitored to determine a remaining capacity of the virtual storage 606. The work load monitor 608 may monitor a work load of the virtual storage system 104. For example, a load of the virtual central processing unit 602 and a load of the virtual memory 604 may be monitored.

As shown in FIG. 6, after the use state of the virtual storage system 104 is determined by using the use state monitor 610, and the work load of the virtual storage system 104 is determined by using the work load monitor 608, if the use state and the work load meet an upgrading requirement at the same time, the target time instant may be determined, and the upgrading trigger 612 is triggered, so that the upgrading trigger 612 generates an upgrading instruction. The upgrading instruction indicates the target time instant of upgrading. Finally, the second preset execution file may be triggered at the target time instant, so that the second preset execution file may shut down the virtual storage system 104 at the target time instant to upgrade the virtual storage system 104. Before upgrading the virtual storage system 104, there is a need to use an allowable capacity detector 614 to determine whether the upgrading requirement meets an allowable capacity of the virtual storage system. If the upgrading requirement does not meet the allowable capacity of the virtual storage system, exception warning information needs to be returned.

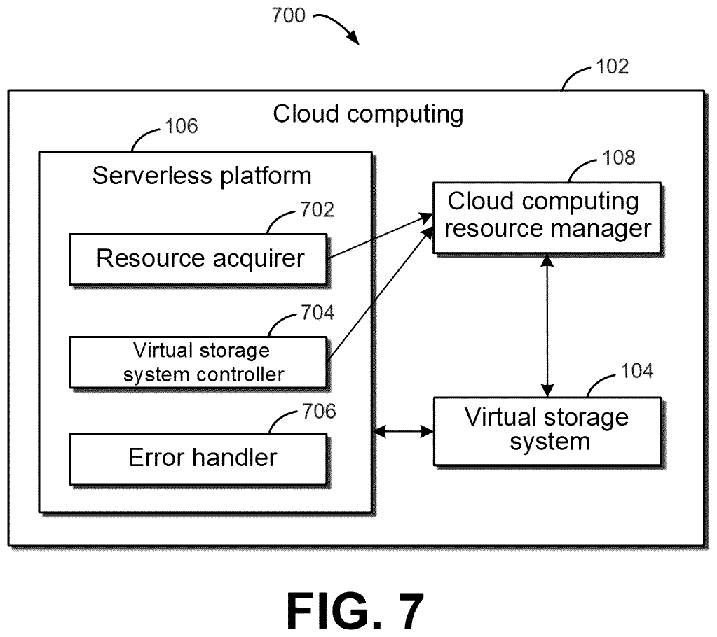

In some embodiments, in order to improve the upgrading efficiency, a plurality of controllers may be deployed on the serverless platform for driving all working process nodes. The preset execution file may select and use all controllers according to a set order to upgrade the virtual storage system. A process of upgrading the virtual storage system according to some embodiments of the present disclosure is described below in conjunction with FIG. 7. FIG. 7 is a schematic diagram of an example environment 700 for upgrading a virtual storage system according to some embodiments of the present disclosure. As shown in FIG. 7, a serverless platform 106 includes a resource acquirer 702, a virtual storage system controller 704, and an error handler 706. The resource acquirer 702 may apply for system resources required for upgrading the virtual storage system from cloud computing 102 through a cloud computing resource manager 108. When applying for the system resources, the resource acquirer 702 may determine the system resources that need to be applied for according to an upgrading type and an upgrading requirement indicated by an upgrading instruction.

As shown in FIG. 7, the virtual storage system controller 704 may determine whether to start up/shut down the virtual storage system according to the upgrading type indicated by the upgrading instruction. The error handler 706 may record an upgrading process and generate a log. The error handler 706 may further return exception warning information in a case of an upgrading failure, so as to prompt a user of the upgrading failure and a reason for the failure. For example, in a case that a license is not obtained, and the system resources cannot be applied for from the cloud computing platform, prompt information of “unavailable cloud resources, and upgrading failed” may be returned to the user.

In some embodiments, as shown in FIG. 7, in a case that the upgrading type indicated by the upgrading instruction is to switch the type of the virtual storage system, after the second preset execution file is triggered, the resource acquirer 702 may be invoked firstly to apply for the system resources required for upgrading the virtual storage system from the cloud computing platform 102 through the cloud API. In a case of determining that the system resources are available, the virtual storage system controller 704 is invoked to shut down the virtual storage system 104. After the upgrading is completed, the virtual storage system controller 704 may be invoked to start up the virtual storage system 104 again.

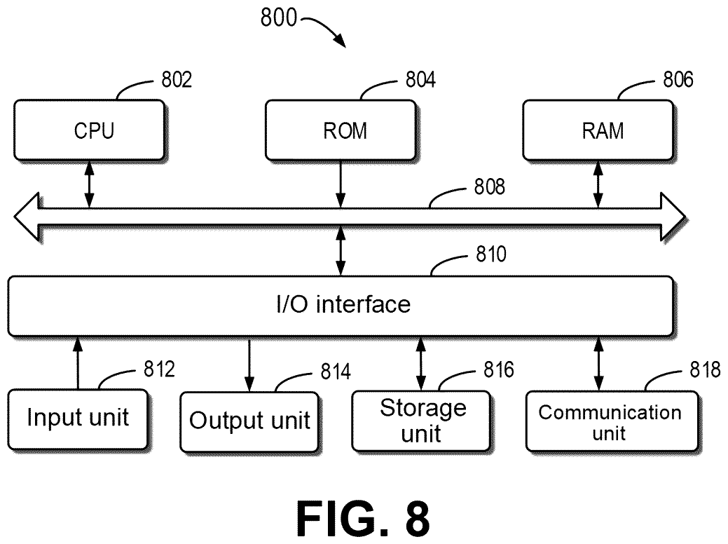

FIG. 8 shows a schematic block diagram of an example device 800 that can be used to implement an embodiment of the present disclosure. As shown in the figure, the device 800 includes a computing unit 801, which may execute various appropriate actions and processing according to computer program instructions stored in a read-only memory (ROM) 802 or computer program instructions loaded from a storage unit 808 onto a random access memory (RAM) 803. Various programs and data required for the operation of the device 800 may also be stored in the RAM 803. The computing unit 801, the ROM 802, and the RAM 803 are connected to each other through a bus 804. An input/Output (I/O) interface 805 is also connected to the bus 804.

A plurality of components in the device 800 are connected to the I/O interface 805, including: an input unit 806, such as a keyboard and a mouse; an output unit 807, such as various types of displays and speakers; a storage unit 808, such as a magnetic disk and an optical disc; and a communication unit 809, such as a network card, a modem, and a wireless communication transceiver. The communication unit 809 allows the device 800 to exchange information/data with other devices via a computer network, such as the Internet, and/or various telecommunication networks.

The computing unit 801 may be various general-purpose and/or special-purpose processing components with processing and computing capabilities. Some examples of the computing unit 801 include, but are not limited to, central processing units (CPUs), graphics processing units (GPUs), various specialized artificial intelligence (AI) computing chips, various computing units for running machine learning model algorithms, digital signal processors (DSPs), and any appropriate processors, controllers, microcontrollers, etc. The computing unit 801 executes various methods and processes described above, such as the method 200. For example, in some embodiments, the method 200 may be implemented as a computer software program that is tangibly included in a machine-readable medium, such as the storage unit 808. In some embodiments, part or all of the computer program may be loaded and/or installed onto the device 800 via the ROM 802 and/or the communication unit 809. When the computer program is loaded to the RAM 803 and executed by the computing unit 801, one or more steps of the method 200 described above may be executed. Alternatively, in other embodiments, the computing unit 801 may be configured to execute the method 200 in any other suitable manners (such as by means of firmware).

The functions described herein above may be executed at least in part by one or more hardware logic components. For example, without limitation, example types of available hardware logic components include: a field programmable gate array (FPGA), an application specific integrated circuit (ASIC), an application specific standard product (ASSP), a system on chip (SOC), a load programmable logic device (CPLD), and the like.

Program code for implementing the method of the present disclosure may be written by using one programming language or any combination of a plurality of programming languages. The program code may be provided to a processor or controller of a general purpose computer, a special purpose computer, or another programmable data processing apparatus, such that the program code, when executed by the processor or controller, implements the functions/operations specified in the flow charts and/or block diagrams. The program code may be executed completely on a machine, executed partially on a machine, executed partially on a machine and partially on a remote machine as a stand-alone software package, or executed completely on a remote machine or server.

In the context of the present disclosure, a machine-readable medium may be a tangible medium that may include or store a program for use by an instruction execution system, apparatus, or device or in connection with the instruction execution system, apparatus, or device. The machine-readable medium may be a machine-readable signal medium or a machine-readable storage medium. The machine-readable medium may include, but is not limited to, an electronic, magnetic, optical, electromagnetic, infrared, or semiconductor system, apparatus, or device, or any suitable combination of the above content. More specific examples of the machine-readable storage medium may include one or more wire-based electrical connections, a portable computer diskette, a hard disk, a random access memory (RAM), a read-only memory (ROM), an erasable programmable read-only memory (EPROM or flash memory), an optical fiber, a portable compact disk read-only memory (CD-ROM), an optical storage device, a magnetic storage device, or any suitable combinations thereof. Additionally, although operations are depicted in a particular order, this should be understood that such operations are required to be performed in the particular order shown or in a sequential order, or that all illustrated operations should be performed to achieve desirable results. Under certain environments, multitasking and parallel processing may be advantageous. Likewise, although the above discussion contains several specific implementation details, these should not be construed as limitations to the scope of the present disclosure. Certain features that are described in the context of separate embodiments may also be implemented in combination in a single implementation. Conversely, various features that are described in the context of a single implementation may also be implemented in a plurality of implementations separately or in any suitable sub-combination.

Although the present subject matter has been described using a language specific to structural features and/or method logical actions, it should be understood that the subject matter defined in the appended claims is not necessarily limited to the particular features or actions described above. Rather, the specific features and actions described above are merely example forms of implementing the claims.

1. A method for upgrading a virtual storage system, applied to a serverless platform and comprising:
receiving an upgrading instruction for the virtual storage system;
determining an upgrading type corresponding to the upgrading instruction and a preset execution file matched with the upgrading type, the preset execution file being pre-deployed in the serverless platform; and
upgrading the virtual storage system by running the preset execution file in the serverless platform.

2. The method according to claim 1, wherein the upgrading type comprises a first upgrading type, the first upgrading type is to add a memory, the preset execution file is a first preset execution file, and upgrading the virtual storage system comprises:
sending a storage resource request to a cloud computing platform by using the first preset execution file;
receiving storage resources allocated by the cloud computing platform for the storage resource request by using the first preset execution file;
configuring a new memory based on the storage resources by using the first preset execution file; and
adding the new memory to the virtual storage system by using the first preset execution file.

3. The method according to claim 2, wherein the storage resource request comprises a size of the storage resources, and the size of the storage resources is determined according to a use state and configuration information of the virtual storage system.

4. The method according to claim 1, wherein the upgrading type comprises a second upgrading type, the preset execution file is a second preset execution file, and upgrading the virtual storage system comprises:
shutting down the virtual storage system by using the second preset execution file;
acquiring system resources required for upgrading the virtual storage system by using the second preset execution file;
upgrading the virtual storage system based on the system resources by using the second preset execution file; and
starting up the virtual storage system by using the second preset execution file.

5. The method according to claim 4, wherein the second upgrading type comprises switching a type of the virtual storage system, different types of virtual storage systems have different configuration information and supported system resources, and acquiring the system resources required for upgrading the virtual storage system by using the second preset execution file comprises:
determining a target switching type of the virtual storage system by using the second preset execution file;
receiving a license corresponding to the target switching type by using the second preset execution file; and
acquiring the system resources required for upgrading the virtual storage system based on the license by using the second preset execution file.

6. The method according to claim 4, wherein the second upgrading type comprises switching a type of the virtual storage system, different types of virtual storage systems have different configuration information and supported system resources, and upgrading the virtual storage system by using the second preset execution file comprises:
reconfiguring the virtual storage system by using the second preset execution file to switch the type of the virtual storage system.

7. The method according to claim 5, wherein determining the target switching type of the virtual storage system comprises:
determining the target switching type of the virtual storage system according to a size of remaining storage data and a data reading speed of the virtual storage system.

8. The method according to claim 4, wherein the second upgrading type comprises expanding a memory of the virtual storage system, and acquiring the system resources required for upgrading by using the second preset execution file comprises:
acquiring an expansion capacity of the memory indicated in the upgrading instruction;
determining whether the expansion capacity meets supported system resources of the virtual storage system by using the second preset execution file; and
acquiring, in response to determining that the expansion capacity meets the supported system resources, the system resources acquired for upgrading the virtual storage system by using the second preset execution file.

9. The method according to claim 4, wherein the second upgrading type comprises expanding a memory of the virtual storage system, and upgrading the virtual storage system by using the second preset execution file comprises:
expanding the memory of the virtual storage system by using the second preset execution file.

10. The method according to claim 4, before shutting down the virtual storage system by using the second preset execution file, further comprising:
determining a target time instant according to a work load and a use state of the virtual storage system; and
triggering the second preset execution file at the target time instant.

11. An electronic device, comprising:
at least one processor; and
a memory coupled to the at least one processor and having an instruction stored thereon, wherein the instruction, when executed by the at least one processor, causes the electronic device to perform actions, comprising:
receiving an upgrading instruction for a virtual storage system;
determining an upgrading type corresponding to the upgrading instruction and a preset execution file matched with the upgrading type, the preset execution file being pre-deployed in a serverless platform; and
upgrading the virtual storage system by running the preset execution file in the serverless platform.

12. The device according to claim 11, wherein the upgrading type comprises a first upgrading type, the first upgrading type is to add a memory, the preset execution file is a first preset execution file, and upgrading the virtual storage system comprises:
sending a storage resource request to a cloud computing platform by using the first preset execution file;
receiving storage resources allocated by the cloud computing platform for the storage resource request by using the first preset execution file;
configuring a new memory based on the storage resources by using the first preset execution file; and
adding the new memory to the virtual storage system by using the first preset execution file.

13. The device according to claim 12, wherein the storage resource request comprises a size of the storage resources, and the size of the storage resources is determined according to a use state and configuration information of the virtual storage system.

14. The device according to claim 11, wherein the upgrading type comprises a second upgrading type, the preset execution file is a second preset execution file, and upgrading the virtual storage system comprises:
shutting down the virtual storage system by using the second preset execution file;
acquiring system resources required for upgrading the virtual storage system by using the second preset execution file;
upgrading the virtual storage system based on the system resources by using the second preset execution file; and
starting up the virtual storage system by using the second preset execution file.

15. The device according to claim 14, wherein the second upgrading type comprises switching a type of the virtual storage system, different types of virtual storage systems have different configuration information and supported system resources, and acquiring the system resources required for upgrading the virtual storage system by using the second preset execution file comprises:
determining a target switching type of the virtual storage system by using the second preset execution file;
receiving a license corresponding to the target switching type by using the second preset execution file; and
acquiring system resources corresponding to the system resources required for upgrading the virtual storage system based on the license by using the second preset execution file.

16. The device according to claim 14, wherein the second upgrading type comprises switching a type of the virtual storage system, different types of virtual storage systems have different configuration information and supported system resources, and upgrading the virtual storage system by using the second preset execution file comprises:
reconfiguring the virtual storage system by using the second preset execution file to switch the type of the virtual storage system.

17. The device according to claim 15, wherein determining the target switching type of the virtual storage system comprises:
determining the target switching type of the virtual storage system according to a size of remaining storage data and a data reading speed of the virtual storage system.

18. The device according to claim 14, wherein the second upgrading type comprises expanding a memory of the virtual storage system, and acquiring the system resources required for upgrading by using the second preset execution file comprises:
acquiring an expansion capacity of the memory indicated in the upgrading instruction;
determining whether the expansion capacity meets supported system resources of the virtual storage system by using the second preset execution file; and
acquiring, in response to determining that the expansion capacity meets the supported system resources, the system resources acquired for upgrading the virtual storage system by using the second preset execution file.

19. The device according to claim 14, wherein the second upgrading type comprises expanding a memory of the virtual storage system, and acquiring the system resources required for upgrading by using the second preset execution file comprises:
expanding the memory of the virtual storage system by using the second preset execution file.

20. A computer program product, the computer program product being tangibly stored on a non-transitory computer-readable medium and comprising a machine-executable instruction, wherein the machine-executable instruction, when executed, causes a machine to perform actions, comprising:
receiving an upgrading instruction for a virtual storage system;
determining an upgrading type corresponding to the upgrading instruction and a preset execution file matched with the upgrading type, the preset execution file being pre-deployed in a serverless platform; and
upgrading the virtual storage system by running the preset execution file in the serverless platform.
